(19) United States
(12) Patent Application Publication
(10) Pub. No.: US 2025/0083199 A1
(43) Pub. Date: Mar. 13, 2025

(54) PIPE BLOCKAGE HANDLING DEVICE

(71) Applicant: HYUNDAEKANGJEON CO., LTD., Changwon-si (KR)

(72) Inventor: Yong Soo KIM, Changwon-si (KR)

(21) Appl. No.: 18/727,487

(22) PCT Filed: Mar. 14, 2022
(86) PCT No.: PCT/KR2022/003501

§ 371 Date: Jul. 9, 2024

(30) Foreign Application Priority Data
Jan. 20, 2022 (KR) 10-2022-0008666

(51) Int. Cl. B08B 9/032

(52) U.S. Cl. CPC B08B 9/0328; B08B 2209/032

(57) ABSTRACT

The present invention relates to a pipe blockage handling device comprising: a main body part in which high-pressure air capable of removing foreign substances blocking a pipe can accumulate, and which accommodates an accumulator; an air compressor which is connected to one side of the main body part and causes air to accumulate inside the main body part, thereby increasing the air pressure and amount of air accumulated in the main body part; a pipe insertion part which is connected to an end of the main body part and expands to a certain volume and shape when injected with the air accumulated in the main body part, wherein the pipe insertion part can seal the inside and outside of a blocked pipe by deforming to conform to the shape of an inlet of the blocked pipe when pressed against the inlet of the blocked pipe, and can seal the inside and outside of the blocked pipe by expanding to conform to the size and shape of the inside of the pipe and coming into close contact with the inner circumferential surface of the pipe when inserted into the inlet of the blocked pipe; and an air pressure discharge part which is provided in the pipe insertion part, communicates with the main body part, and is bendable. Also, the air pressure discharge part causes the high-pressure air accumulated inside the main body part to be discharged into the blocked pipe that is sealed at the inlet by the pipe insertion part, thus making it possible to effectively remove foreign substances in the blocked pipe. In addition, the present invention has the effect that foreign substances accumulated in the pipe can be removed by high-pressure air. Moreover, since the air pressure discharge part expands so as to come into close contact with the inner circumferential surface of the pipe while inserted in the pipe, the present invention has the effect that the inside of the pipe can be sealed regardless of the diameter of the pipe.

### TECHNICAL FIELD

The present invention relates to a pipe blockage handling device, and more particularly, to a pipe blockage handling device capable of handling a pipe blockage by applying an air pressure to a pipe having an inside blocked by foreign substances.

### BACKGROUND ART

In general, when a toilet, a pipe, or the like is blocked with foreign substances, the foreign substances may not be removed with a normal water pressure. In this case, a device such as a drain cleaner or a plunger has to be used. However, it may be difficult to use the drain cleaner or the plunger when a curved pipe, a pipe that does not match a size of an end of the device, or the like is blocked. In addition, when sizes of the pipe and the device do not match, a pressure may leak so that the pressure may not be easily transmitted to the foreign substances.

As a document of the related art to solve such problems of a conventional pipe blockage handling device, Korean Unexamined Patent Publication No. 10-2020-0077318 has disclosed a stick drain cleaner capable of dissolving and eliminating foreign substances when inserted into a drain pipe blocked with the foreign substances.

However, according to such a conventional technology, it may be difficult to remove the foreign substances when the foreign substances are not dissolved by chemicals, when the foreign substances are accumulated in large quantities, or when the foreign substances are accumulated deep in the pipe.

### DISCLOSURE

### Technical Problem

The present invention has been devised to solve the problems of the related art as described above, and an object of the present invention is to effectively remove foreign substances by sealing an inlet of a pipe blocked by the foreign substances and applying an air pressure to the blocked pipe.

### Technical Solution

According to an exemplary embodiment of the present invention, a pipe blockage handling device includes: a main body part in which high-pressure air capable of removing foreign substances that block a pipe is accumulated, and configured to accommodate an accumulator; an air compressor connected to one side of the main body part, and configured to accumulate air inside the main body part so that an air pressure and an accumulation amount are increased; a pipe insertion part connected to an end of the main body part to expand to a preset volume and a preset shape when injected with the air accumulated in the main body part, deformed to correspond to a shape of an inlet of a blocked pipe so as to seal an inside and an outside of the blocked pipe when pressed in close contact with the inlet of the blocked pipe, and configured to expand to correspond to a size and a shape of the inside of the pipe to make close contact with an inner circumferential surface of the pipe so as to seal the inside and the outside of the pipe when inserted into the inlet of the blocked pipe; and an air pressure discharge part provided inside the pipe insertion part, configured to communicate with the main body part, and configured to be bendable. In addition, the air pressure discharge part allows the high-pressure air accumulated inside the main body part to be discharged into the blocked pipe having the inlet that is sealed by the pipe insertion part, so that the foreign substances in the blocked pipe are effectively removed.

### Advantageous Effects

By using the solution for achieving the above object, according to the present invention, foreign substances that block a pipe can be removed through high-pressure air.

In addition, according to the present invention, a pipe insertion part may expand in volume to make close contact with an inner circumferential surface of the pipe while being inserted into an inlet of the pipe, so that an inside of the pipe can be sealed regardless of a diameter of the pipe.

In addition, according to the pipe insertion part of the present invention, the pipe insertion part formed of a material having stretchability and an air pressure discharge part formed in a bellows hose structure may be bent so as to be easily inserted even into a pipe having a complex bending structure that makes it difficult to use a tool such as a plunger, so that the foreign substances can be removed.

In addition, even when the pipe insertion part is not inserted into the pipe, when the pipe insertion part expands in a trumpet shape, an outside of the pipe insertion part may correspond to a shape or a curve of a joint surface while a pressure of an inside of the pipe insertion part is the same, so that the pipe insertion part may make close contact with the pipe when joined and pressed to the pipe, and thus an air pressure discharged from the air pressure discharge part can be transmitted to the foreign substances that block the pipe without a loss.

In addition, according to the present invention, an accumulator may be provided, so that a high air pressure can be prepared even with a pump and an electric motor having a small capacity and a small output.

### DESCRIPTION OF DRAWINGS

FIG. 1 is a view showing a pipe blockage handling device according to a first embodiment of the present invention.

FIG. 2 is an exploded perspective view showing the pipe blockage handling device according to the first embodiment of the present invention.

FIG. 3 is a sectional view showing the pipe blockage handling device according to the first embodiment of the present invention.

FIG. 4 is a sectional view showing a state in which a pipe injection part expands in the pipe blockage handling device according to the first embodiment of the present invention.

FIG. 5 is a view showing a state in which the pipe injection part expands to seal an inlet of a blocked pipe, and an air pressure discharge part discharges high-pressure air into the blocked pipe in the pipe blockage handling device according to the first embodiment of the present invention.

FIG. 6 is a sectional view showing, from the top, the pipe blockage handling device according to the first embodiment of the present invention.

FIG. 7 is a sectional view showing a one-way valve of an air compressor according to the first embodiment of the present invention.

FIG. 8 is a sectional view showing the pipe blockage handling device according to the first embodiment of the present invention, and a perspective view showing a detailed configuration of an injection part valve and a discharge part valve.

FIG. 9 is a sectional view showing the pipe blockage handling device according to the first embodiment of the present invention, in which a discharge part trigger is pulled to open a discharge part cap.

FIG. 10 is a view showing a state in which a pipe is sealed by the pipe blockage handling device according to the first embodiment of the present invention.

FIG. 11 is a view showing a state in which air inside the pipe injection part is discharged by the injection part valve according to the first embodiment of the present invention.

FIG. 12 is a view showing a state in which an air hose is fastened to the pipe blockage handling device according to the first embodiment of the present invention.

FIGS. 13 to 16 are views showing states in which the pipe blockage handling device according to the first embodiment of the present invention is used.

FIG. 17 is a sectional view showing a pipe blockage handling device according to a second embodiment of the present invention.

FIG. 18 is a view showing a pipe blockage handling device according to a third embodiment of the present invention.

FIG. 19 is a sectional view showing the pipe blockage handling device according to the third embodiment of the present invention, in which a projectile loaded.

FIG. 20 is a sectional view showing the pipe blockage handling device according to the third embodiment of the present invention, in which the projectile is launched.

### MODE FOR INVENTION

Terms used herein will be briefly described, and the present invention will be described in detail.

Regarding the terms used herein, general terms that are currently used as widely as possible are selected in consideration of functions thereof in the present invention. However, the terms may vary according to the intention of those skilled in the art, judicial precedents, the emergence of new technologies, and the like. Therefore, the terms used herein are to be defined based on the meanings of the terms and the overall contents of the present invention without being simply limited to names of the terms.

Throughout the present disclosure, when some part ‘includes’ some elements, it means that other elements may be further included but not excluded unless specifically described to the contrary.

Hereinafter, embodiments of the present invention will be described in detail with reference to the accompanying drawings so that a person having ordinary skill in the art to which the present invention pertains may easily practice the present invention. However, the present invention may be embodied in various different forms, and is not limited to the embodiments described herein.

Specific details, including the object of the present invention, the solution for achieving the object, and the effect of the invention, will be included in the embodiments and the drawings that will be described below. Advantages and features of the present invention and methods for accomplishing the same will become clear with reference to the following detailed description of the embodiments taken in conjunction with the accompanying drawings.

Hereinafter, a pipe blockage handling device according to the present invention will be described in detail with reference to the accompanying drawings.

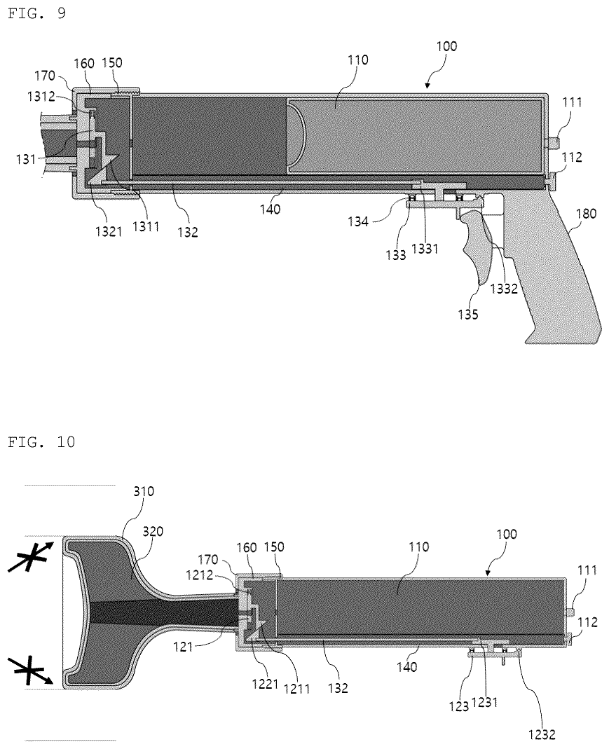

Referring to FIGS. 1 to 11, according to an exemplary first embodiment of the present invention, a pipe blockage handling device may include: a main body part 100 in which high-pressure air capable of removing foreign substances that block a pipe is accumulated, and configured to accommodate an accumulator 110; an air compressor 200 connected to one side of the main body part 100, and configured to accumulate air inside the main body part 100 so that an air pressure inside the main body part 100 is increased to a preset upper limit pressure; a pipe insertion part 300 connected to an end of the main body part 100 to expand to a preset volume and a preset shape when injected with the air in the main body part 100, deformed to correspond to a shape of an outer wall, an inlet, or the like of a blocked pipe so as to seal an inside and an outside of the blocked pipe when pressed in close contact with the outer wall, the inlet, or the like of the blocked pipe, and configured to expand to correspond to a size and a shape of the inside of the pipe to make close contact with an inner circumferential surface of the pipe so as to seal the inside and the outside of the pipe when inserted into the inlet of the blocked pipe; and an air pressure discharge part 400 provided inside the pipe insertion part 300, configured to communicate with the main body part 100, and configured to be bendable. In addition, the air pressure discharge part 400 may allow the high-pressure air accumulated inside the main body part 100 to be discharged into the blocked pipe having the inlet that is sealed by the pipe insertion part 300, so that the foreign substances in the blocked pipe may be effectively removed.

First, the main body part 100 may serve to maintain a high air pressure by filling the main body part 100 with the air. In more detail, the main body part 100 may include: an accumulator 110 provided inside the main body part 100; an injection part valve 120 configured to open and close a portion in which the pipe insertion part 300 and the main body part 100 are connected to each other; a discharge part valve 130 configured to open and close a portion in which the air pressure discharge part 400 and the main body part 100 are connected to each other; a valve partition member 140 configured to separate the injection part valve 120 and the discharge part valve 130 from the accumulator 110; a main body partition member 150 provided at the end of the main body part 100 to separate the accumulator 110 from the injection part valve 120 and the discharge part valve 130; a communication part 160 bonded and connected to the main body partition member 150; a connection bracket 170 covering the communication part 160, and fastened to the end of the main body part 100; and a handle 180 provided on one side of the main body part 100.

In addition, the accumulator 110 may accommodate a compressive fluid therein, and may be formed of an elastic material so as to be contracted when a pressure is applied, and restored to an original state thereof when the pressure is released. In other words, the accumulator 110 may be contracted when the main body part 100 is filled with the air to increase the pressure, and a pressure inside the accumulator 110 may be increased. In this case, the accumulator 110 may be compressed in one direction, so that the air filling an inside of the main body part 100 may be compressed in an opposite direction of the direction in which the accumulator 110 is compressed. In addition, the accumulator 110 may include: a filling part 111 provided at a portion in which an end of the accumulator 110 and the main body part 100 make contact with each other; and a pressure gauge 112 configured to indicate the pressure inside the main body part 100. The filling part 111 may fill the accumulator 110 with the compressive fluid, so that the air pressure maintained inside the main body part 100 may be adjusted. In addition, the accumulator 110 may allow the air pressure inside the main body part 100 to be maintained at a high pressure and allow the air to be effectively discharged, so that the air pressure may be maintained at a high pressure to easily remove the foreign substances in the blocked pipe.

In addition, the injection part valve 120 may serve to allow the air inside the main body part 100 to be injected into the pipe insertion part 300. For example, the injection part valve 120 may include: an injection part cap 121 configured to block an inlet through which the air inside the main body part 100 is injected into the pipe insertion part 300; an injection part valve rod 122 connected to the injection part cap 121; an injection part valve operation part 123 connected to an end of the injection part valve rod 122; and a first elastic pressing part 124 configured to press the injection part valve operation part 123. First, the injection part cap 121 may be provided in the form of a cap that covers a portion in which the air inside the main body part 100 communicates with the pipe insertion part 300, and may have a hole through which the air passes. In addition, the injection part cap 121 may include: a first sliding member 1211 that protrudes from one surface of the injection part cap 121 so as to be bent downward; and a first spring 1212 configured to press an upper portion of the injection part cap 121. The first sliding member 1211 may be provided in the form of a sharp end facing downward to have an inclined surface. In addition, the first spring 1212 may prevent the hole of the injection part cap 121 from facing a hole of the communication part 160 corresponding to the pipe insertion part 300 by the pressing, so that the air inside the main body part 100 may be prevented from flowing into the pipe insertion part 300. In addition, the injection part valve rod 122 may be provided in the form of a rod provided in a longitudinal direction of the main body part 100, and may be accommodated in the main body part 100. In addition, the injection part valve rod 122 may include a second sliding member 1221 provided in the form of a sharp end facing the first sliding member 1211 to have an inclined surface making contact with the inclined surface of the first sliding member 1211. In addition, the injection part valve operation part 123 may be inserted from an outer circumferential surface of the main body part 100 so as to be connected to the end of the injection part valve rod 122. In this case, the injection part valve operation part 123 may include: a first seating groove part 1231 in which the injection part valve rod 122 is inserted and seated; and a first hook part 1232 configured to temporarily fix the injection part valve operation part 123 to the main body part 100. In addition, the injection part valve operation part 123 may have an ‘I’ shape having a minimum length so as to reciprocally move in the longitudinal direction of the main body part 100, and may have an upper portion that is partially inserted into the main body part 100 such that the upper portion of the injection part valve operation part 123 is disposed on an inner lower side of the main body part 100, and a lower portion of the injection part valve operation part 123 is disposed on an outer lower side of the main body part 100. In addition, the first hook part 1232 may protrude from one surface of the injection part valve operation part 123 toward the outer circumferential surface of the main body part 100, and may temporarily fix the injection part valve operation part 123 when latched to a latching rod provided in the main body part 100. In addition, the first elastic pressing part 124 may be provided between the outer circumferential surface of the main body part 100 and the injection part valve operation part 123, and may be configured as two coil springs to press the injection part valve operation part 123 downward, so that the injection part valve operation part 123 may be prevented from being separated, and a bottom surface of an upper portion of the ‘I’ shape of the injection part valve operation part 123 may make close contact with a lower inner bottom surface of the main body part 100 so as to prevent the air from leaking. In other words, when the injection part valve operation part 123 is pressed forward, the injection part valve rod 122 may be moved, and the second sliding member 1221 may push the first sliding member 1211 upward, so that the injection part cap 121 may be moved upward. In addition, when the injection part cap 121 is moved upward, the hole of the communication part 160 and the hole of the injection part cap 121 may face each other, so that a passage may be opened, and thus the air inside the main body part 100 may be injected into the pipe insertion part 300.

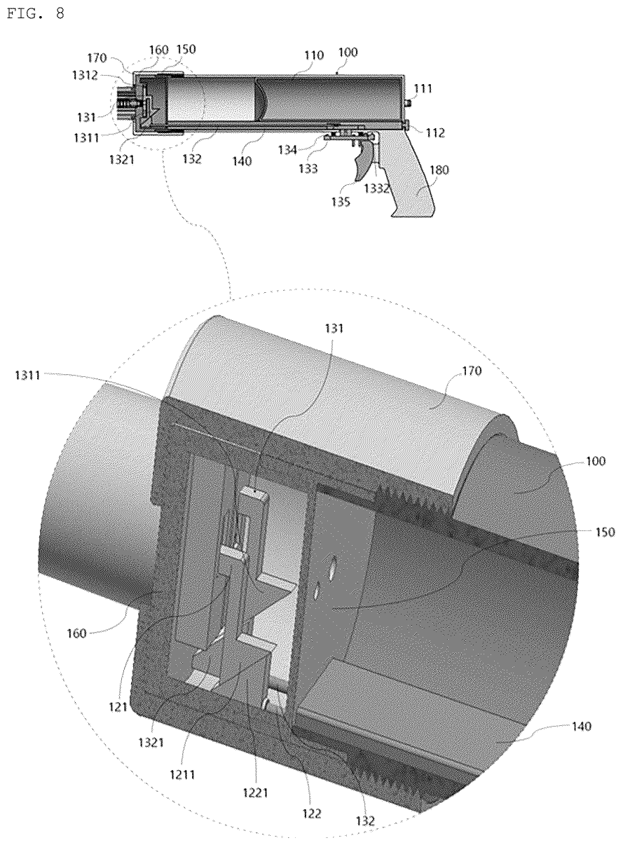

In addition, the discharge part valve 130 may serve to allow the air inside the main body part 100 to be discharged through the air pressure discharge part 400. For example, the discharge part valve 130 may include: a discharge part cap 131 configured to block an inlet through which the air inside the main body part 100 is discharged to the air pressure discharge part 400; a discharge part valve rod 132 connected to the discharge part cap 131; a discharge part valve operation part 133 connected to an end of the discharge part valve rod 132; a second elastic pressing part 134 configured to press the discharge part valve operation part 133; and a discharge part trigger 135 connected to the discharge part valve operation part 133. First, the discharge part cap 131 may be provided in the form of a cap that covers a portion in which the air inside the main body part 100 communicates with the air pressure discharge part 400, and may have a hole through which the air passes. In addition, the discharge part cap 131 may include: a third sliding member 1311 that protrudes from one surface of the discharge part cap 131 so as to be bent downward; and a second spring 1312 configured as a spring configured to press an upper portion of the discharge part cap 131. The third sliding member 1311 may be provided in the form of a sharp end facing downward to have an inclined surface. In addition, the second spring 1312 may prevent the hole of the discharge part cap 131 from facing a hole of the communication part 160 corresponding to the air pressure discharge part 400 by the pressing, so that the air inside the main body part 100 may be prevented from being discharged through the air pressure discharge part 400. In addition, the discharge part valve rod 132 may be provided in the form of a rod provided in the longitudinal direction of the main body part 100, and may be arranged in parallel with the injection part valve rod 122. In addition, the discharge part valve rod 132 may include a fourth sliding member 1321 provided in the form of a sharp end facing the third sliding member 1311 to have an inclined surface making contact with the inclined surface of the third sliding member 1311. In addition, the discharge part valve operation part 133 may be inserted from the outer circumferential surface of the main body part 100 so as to be connected to the end of the discharge part valve rod 132. In this case, the discharge part valve operation part 133 may include: a second seating groove part 1331 in which the discharge part valve rod 132 is inserted and seated; and a second hook part 1332 configured to temporarily fix the discharge part valve operation part 133 to the main body part 100. In addition, the discharge part valve operation part 133 may have an ‘I’ shape having a minimum length so as to reciprocally move in the longitudinal direction of the main body part 100, and may have an upper portion that is partially inserted into the main body part 100 such that the upper portion of the discharge part valve operation part 133 is disposed on the inner lower side of the main body part 100, and a lower portion of the discharge part valve operation part 133 is disposed on the outer lower side of the main body part 100. In addition, the second elastic pressing part 134 may be provided between the outer circumferential surface of the main body part 100 and the discharge part valve operation part 133, and may be configured as two springs to press the discharge part valve operation part 133 downward, so that the discharge part valve operation part 133 may be prevented from being separated, and a bottom surface of an upper portion of the ‘I’ shape may make close contact with a lower inner surface of the main body part 100 so as to prevent the air from leaking. In addition, referring to FIG. 8, when one side of the discharge part trigger 135 is pulled, an opposite side of the discharge part trigger 135 may press the discharge part valve operation part 133 forward. In other words, the discharge part valve 130 may be configured such that when the discharge part trigger 135 is pulled, the discharge part valve operation part 133 may be pressed forward, the discharge part valve rod 132 may be moved, and the fourth sliding member 1321 may push the third sliding member 1311 upward, so that the discharge part cap 131 may be moved upward. In addition, when the discharge part cap 131 is moved upward, the hole of the discharge part cap 131 and the hole of the communication part 160 corresponding to the air pressure discharge part 400 may face each other, so that a passage may be formed, and thus the air inside the main body part 100 may be discharged through the air pressure discharge part 400. Therefore, the discharge part valve 130 may be disposed in parallel with the injection part valve 120 so as to control a flow of the air through the air pressure discharge part 400. In addition, the injection part valve 120 and the discharge part valve 130 may allow the air inside the main body part 100 to selectively communicate with the pipe insertion part 300 and the air pressure discharge part 400 so that the flow of the air may be controlled.

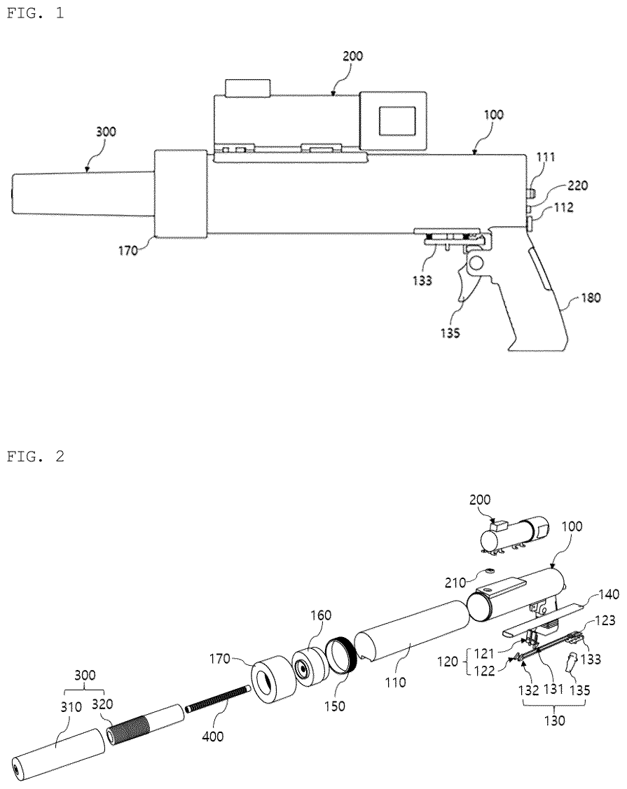

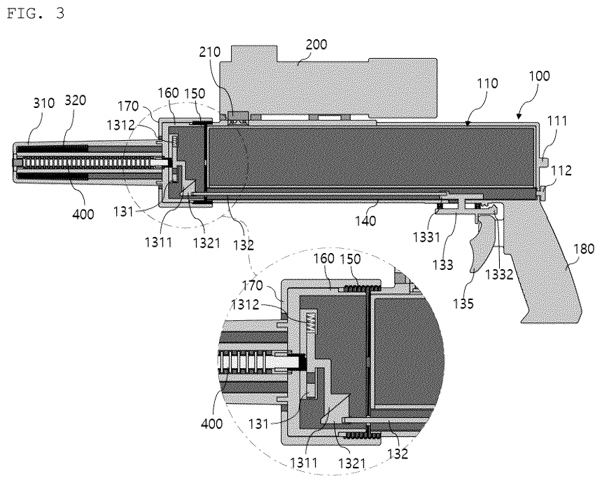

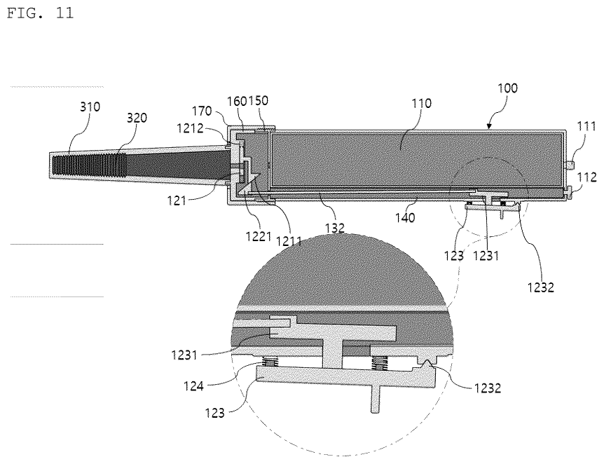

In addition, as shown in FIG. 2 and the enlarged view of FIG. 8, the valve partition member 140 may serve to separate the injection part valve 120 and the discharge part valve 130 from the accumulator 110 so that the injection part valve 120 and the discharge part valve 130, which are inserted into a lower portion of the main body part 100, may not interfere with the accumulator 110 upon expansion and contraction of the accumulator 110. For example, the valve partition member 140 may be provided in the longitudinal direction of the main body part 100 to have a hollow shape. In addition, the valve partition member 140 may make close contact with a lower portion of an inner circumferential surface of the main body part 100. In addition, the valve partition member 140 may have a hollow part configured to accommodate the injection part valve rod 122 and the discharge part valve rod 132. In addition, the valve partition member 140 may be formed on a lower side thereof with a hole so that the upper portions of the injection part valve operation part 123 and the discharge part valve operation part 133, which are inserted and coupled to the main body part 100 from the outer circumferential surface of the main body part 100, may be inserted into the hole. In other words, when the injection part valve operation part 123 and the discharge part valve operation part 133 are pressed by the first elastic pressing part 124 and the second elastic pressing part 134, the bottom surfaces of the upper portions of the ‘I’ shapes of the discharge part valve operation part 133 and the injection part valve operation part 123 may strongly make close contact with the lower portion of the inner circumferential surface of the main body part 100. In this case, as shown in FIG. 11, while the injection part cap 121 is opened, and the pipe insertion part 300 expands, when the injection part valve operation part 123 is pressed toward an upper side of the main body part 100 on an upper side of the injection part valve operation part 123 as shown in the enlarged view of FIG. 11, the spring of the first elastic pressing part 124 may be contracted, and the bottom surface of the upper portion of the ‘I’ shape of the injection part valve operation part 123 and a bottom surface of the lower portion of the main body part 100 may be separated from each other, so that the air injected into the pipe insertion part 300 may be discharged to an outside.

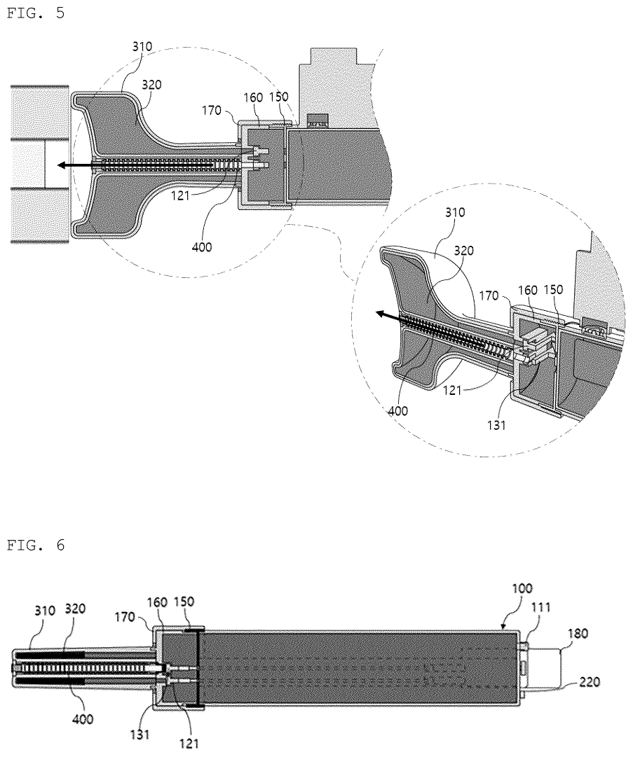

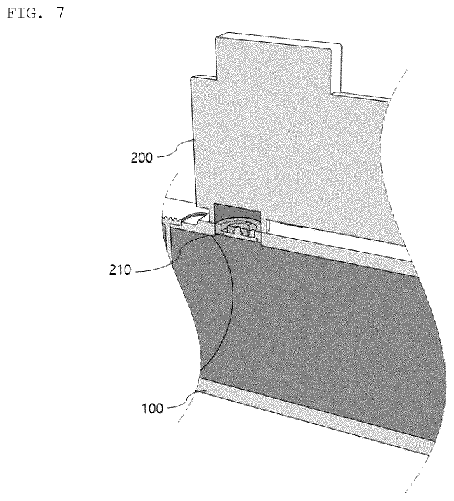

In addition, referring to FIG. 6 and the enlarged view of FIG. 8, the main body partition member 150 may be provided at the end of the main body part 100 to make contact with the accumulator 110, and may prevent the accumulator 110 from being separated to the outside. In addition, the main body partition member 150 may have a plurality of holes to prevent interference with operations of the injection part valve rod 122 and the discharge part valve rod 132 and the movement of the air. In addition, the main body partition member 150 may have a stepped edge so that the communication part 160 and the main body part 100 may be easily seated.

In addition, a central portion of the communication part 160 may have both vertical surfaces, one surface of the communication part 160 may be provided between the injection part cap 121 and the discharge part cap 131 and the pipe insertion part 300 and the air pressure discharge part 400, and an opposite surface (the other surface) of the communication part 160 may be provided between the injection part cap 121 and the discharge part cap 131 and the first sliding member 1211 and the third sliding member 1311. In other words, the injection part cap 121 and the discharge part cap 131 may be provided between the both surfaces (the one surface and the opposite surface) of the central portion of the communication part 160 provided as described above, and may lightly make contact with the both surfaces to slidably move upward and downward. In addition, as shown in FIGS. 8 to 11, the communication part 160 may be formed on the one surface thereof with holes configured to communicate with the pipe insertion part 300 and the air pressure discharge part 400, respectively, and may be formed on the opposite surface (the other surface) thereof with vertical grooves so that the first sliding member 1211 and the third sliding member 1311 may operate upward and downward as shown in the enlarged view of FIG. 8, and the injection part cap 121 and the discharge part cap 131 may move upward and downward between the one surface and the opposite surface so that the flow of the air may be controlled. In other words, the air inside the main body part 100 may pass through the vertical grooves in which the first sliding member 1211 and the third sliding member 1311 move, and pass through the hole of the injection part cap 121 and the hole of the discharge part cap 131, and the holes of the communication part 160 corresponding thereto so as to be injected into the pipe insertion part 300 or discharged through the air pressure discharge part 400. In more detail, the first sliding member 1211 and the third sliding member 1311 may be moved upward by the movements of the second sliding member 1221 and the fourth sliding member 1321 toward the communication part 160. In this case, when the hole of the injection part cap 121 and the hole 4 the discharge part cap 131 are aligned with the corresponding holes of the communication part 160 on the same line, the air maybe discharged, respectively, and when the hole of the injection part cap 121 and the hole of the discharge part cap 131 are not aligned with the corresponding holes of the communication part 160 on the same line, the discharge of the air may be blocked. In addition, while the holes of the injection part cap 121 and the discharge part cap 131 are not aligned with the corresponding holes of the communication part 160 on the same line, respectively, the air pressure of the main body part 100 may press the injection part cap 121 and the discharge part cap 131, so that each of the injection part cap 121 and the discharge part cap 131 may make close contact with the one surface of the communication part 160 so as to be sealed, and thus the discharge of the air may be blocked. In the same context as above, in order to prevent backflow of the high-pressure air injected into the pipe injection part 300 or discharged from the air pressure discharge part 400, when the holes of the injection part cap 121 and the discharge part cap 131 are not located on the same line as the corresponding holes of the communication part 160, the opposite surface (a surface having the grooves) may make close contact with the injection part cap 121 and the discharge part cap 131 so as to be sealed even when the high-pressure air inside the pipe injection part 300 and the air pressure discharge part 400 press the injection part cap 121 and the discharge part cap 131, so that the backflow may be prevented. In this case, when the opposite surface is not provided, the injection part cap 121 and the discharge part cap 131 may not make close contact with the opposite surface so as to be sealed, so that the backflow may not be prevented, and thus the communication part 160 has to have the both surfaces (the one surface and the opposite surface).

In addition, the connection bracket 170 may be provided in the form of a hollow cylinder to surround the main body partition member 150 and the communication part 160, and may be fastened to the end of the main body part 100 so that the main body partition member 150 and the communication part 160 may be firmly fixed and sealed. In addition, as shown in the enlarged view of FIG. 8, the connection bracket 170 may have an end engaged with the pipe insertion part 300 to allow the communication part 160 to which the pipe insertion part 300 is fixed and the main body partition member 150 to be fastened to the end of the main body part 100.

Next, the air compressor 200 may be connected to one side of the main body part 100 to fill the main body part 100 with the air. For example, the air compressor 200 may be electrically powered to generate a power by a power system (not shown) provided on one side of the air compressor 200 to inject external air into the main body part 100. In addition, the air compressor 200 may include: a one-way valve 210 installed in an inlet through which the air is injected from the air compressor 200 into the main body part 100; and a pressure restriction switch 220 configured to interwork with the pressure gauge 112, and control an operation of the air compressor to stop when the pressure inside the main body part reaches a preset upper limit pressure. In addition, the one-way valve 210 may be opened to inject the air into the main body part 100 when the air pressure is applied from the air compressor 200 toward the main body part 100. In contrast, the one-way valve 210 may not be opened to maintain the air pressure inside the main body part 100 when the air pressure is applied from the main body part 100 toward the air compressor 200.

In addition, the pressure restriction switch 220 may stop the operation of the air compressor 200 to stop introduction of the air into the main body part 100 when the pressure measured by the pressure gauge 112 reaches the preset upper limit pressure, and may allow the operation of the air compressor 200 and the introduction of the air when the pressure inside the main body part 100 is insufficient.

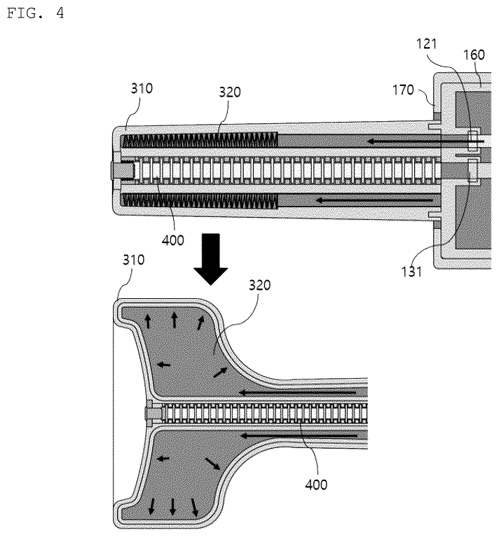

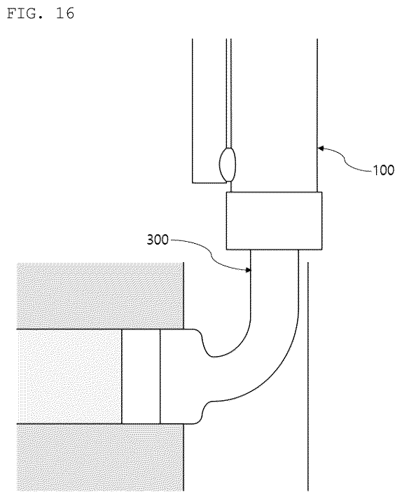

Next, the pipe insertion part 300 may be formed of an elastic material so as to be flexibly bent, so that the pipe insertion part 300 may be easily inserted into a curved pipe. For example, the pipe insertion part 300 may include: an outer tube 310 formed of a flexible material having elasticity, and having a hollow shape; and an expansion limit pocket 320 accommodated between an outer circumferential surface and an inner circumferential surface of the outer tube 310, formed of a flexible non-elastic material, and configured to communicate with the main body part 100. In addition, the expansion limit pocket 320 may expand in a trumpet shape as shown in FIG. 16 when the air inside the main body part 100 is injected. In addition, the outer tube 310 may expand together with the expansion limit pocket 320 by the expansion limit pocket 320 to make close contact with inner circumferential surfaces of blocked pipes having various sizes and shapes, so that an inlet of the blocked pipe may be sealed. In more detail, the outer tube 310 may be provided in the form of a hollow cylinder so that the air pressure discharge part 400 may be accommodated in a hollow part. In addition, the outer tube 310 may have an accommodation space between the inner circumferential surface and the outer circumferential surface. In addition, the expansion limit pocket 320 may be provided in the accommodation space provided between the inner circumferential surface and the outer circumferential surface of the outer tube 310. In this case, the expansion limit pocket 320 may be press-fitted into the outer tube 310 in the form of a parachute having a plurality of creases, and may expand in a shape within a preset volume range when the air inside the main body part 100 is injected, so that while the outer tube 310 is prevented from expanding to a limit or more, the pipe insertion part 300 may make close contact with the inlet of the blocked pipe, and the outer tube 310 may be prevented from being subjected to plastic deformation. For example, the expansion limit pocket 320 may expand in a trumpet shape in which one end has a greater diameter than an opposite end. In other words, the expansion limit pocket 320 may expand in a shape in which an end has a large diameter as shown in FIG. 4 without expanding in a round shape like a typical balloon when the air is injected. In addition, the expansion limit pocket 320 may be formed of a non-elastic material capable of maintaining airtightness so that there may be a limit to an expansion volume, and thus the outer tube 310 expanding together with the expansion limit pocket 320 may not expand to exceed the preset volume range. In addition, in a case where the pipe insertion part 300 is inserted into the pipe, while the outer tube 310 has a property to expand in the trumpet shape by the expansion limit pocket 320, when the outer tube 310 is restrained from expanding to the limit of the expansion limit pocket 320 due to a structure and a size of an inside of the blocked pipe, the outer tube 310 may make close contact with the blocked pipe so as to be sealed at a restraining point. Accordingly, the pressure of the air discharged from the air pressure discharge part 400 may be completely transmitted to the inside of the pipe, so that the foreign substances may be easily removed. In addition, when a blockage of a pipe having a structure and a size that do not allow the pipe insertion part 300 to enter the pipe is handled, the outer tube 310 may expand to the limit and make close contact with the outer wall or the inlet of the blocked pipe so as to be pressed (pressurized) such that the pipe insertion part 300 may be deformed to correspond to the contact surface, and the high-pressure air may be discharged from the air pressure discharge part 400, so that the pipe insertion part 300 and the outer wall or the inlet may make close contact with each other so as to be sealed, and thus the high-pressure air may be prevented from leaking, and the foreign substances may be removed more easily.

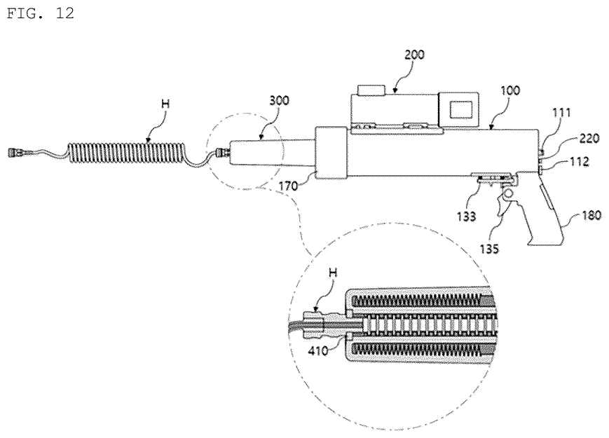

Next, the air pressure discharge part 400 may be opened and closed by an operation of the discharge part valve 130 so as to discharge the air inside the main body part 100. For example, the air pressure discharge part 400 may be a flow path formed from one end of the hollow part of the pipe insertion part 300 to an opposite end of the hollow part of the pipe insertion part 300, in which the air may be discharged from an end of the air pressure discharge part 400. In addition, referring to FIG. 12, the air pressure discharge part 400 may have an end to which an air hose H is connected so as to enable use and air charging of an of air tool. For example, a discharge port 410 to which the air hose H configured to inject the air into an air tacker, a soccer ball, a tire, and the like is connected may be provided at the end of the air pressure discharge part 400. Therefore, the air may be injected into the air tacker, the soccer ball, the tire, and the like through the air discharged from the air pressure discharge part 400.

In other words, when the air compressor 200 injects the air into the main body part 100, a high air pressure may be accumulated and maintained inside the main body part 100 by the accumulator 110. In addition, while the accumulator 110 is compressed by the air pressure, when the injection part valve operation part 123 moves forward, the injection part cap 121 may move upward to allow the pipe insertion part 300 and the main body part 100 to communicate with each other, so that the pipe insertion part 300 may be injected with the air so as to expand. In addition, while the injection part valve operation part 123 moves rearward to maintain an expansion state of the pipe insertion part 300, when the discharge part trigger 135 is pulled, the discharge part cap 131 may move upward to allow the air pressure discharge part 400 and the main body part 100 to communicate with each other, so that the high-pressure air that has been maintained may be discharged through the air pressure discharge part 400. In this case, when the air inside the main body part 100 is partially first injected into the pipe insertion part 300 to decrease the air pressure, or when the foreign substances in the blocked pipe are not removed at once, the air compressor 200 may accumulate the air so that the pressure inside the main body part 100 may reach the preset upper limit pressure, so that a pipe blockage may be handled with the upper limit pressure by the pipe blockage handling device according to the present invention. In addition, while the discharge part valve operation part 133 moves forward to close the discharge part valve 130, when the injection part valve operation part 123 is pressed in a centrifugal direction of the main body part 100, a gap may be formed between the inner circumferential surface of the main body part 100 and a bottom surface of an upper side of the injection part valve operation part 123, so that the air that has expanded the pipe injection part 300 may be discharged.

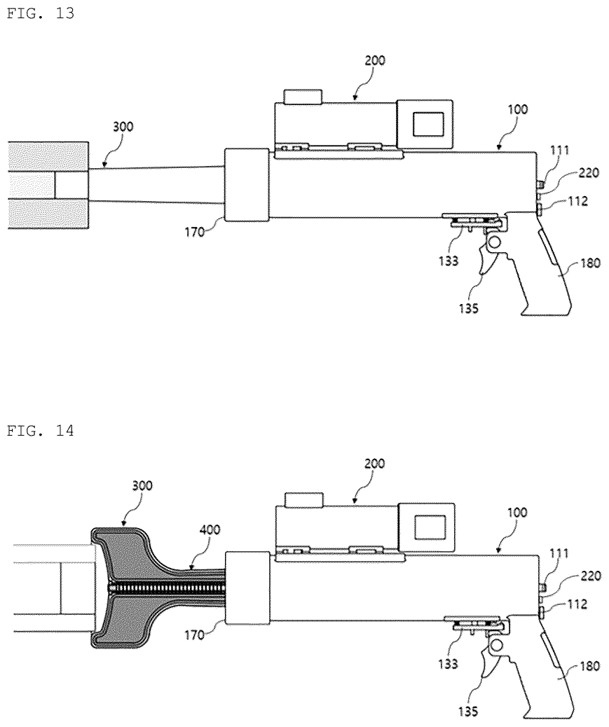

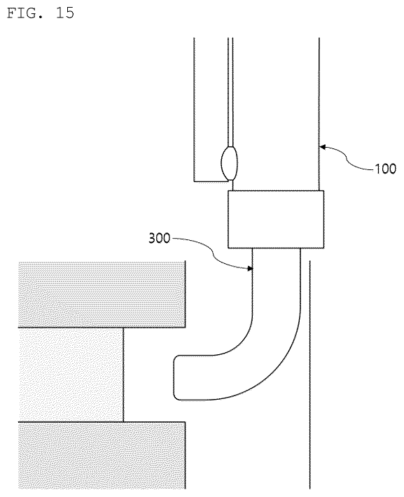

In addition, referring to FIGS. 13 to 16, according to the pipe blockage handling device of the present invention, the pipe insertion part 300 may make close contact with a pipe having a small diameter, and the pipe insertion part 300 may be bent and inserted into a pipe in which a space on a front side of an inlet of the pipe is bent so as to expand, so that the foreign substances in the pipe may be removed. In addition, the air pressure discharge part 400 may include a cover provided on the inner circumferential surface of the expansion limit pocket 320, provided as a bendable hose having a bellows shape so as to be inserted even into the curved pipe, and configured to prevent introduction of external foreign substances.

Hereinafter, a pipe blockage handling device according to a second embodiment of the present invention will be described. The present embodiment is partially different from the first embodiment in that the air compressor is provided in a manual pump type, and the descriptions of the first embodiment will be hereby incorporated by reference for other redundant configurations.

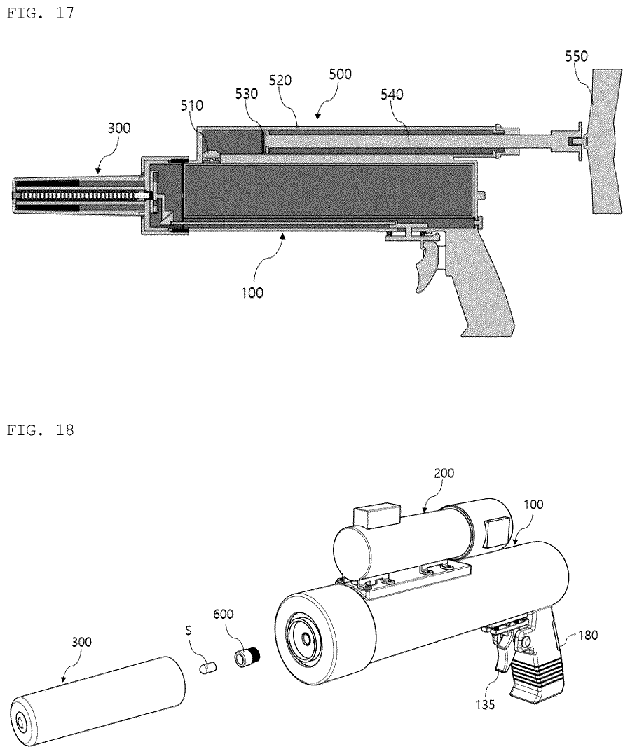

Referring to FIG. 17, according to the present invention, the pipe blockage handling device may include an air compressor 500 provided in a manual pump type, and connected to an upper portion of the main body part 100. In addition, the air compressor 500 may include: a one-way valve 510 installed in an inlet through which the air is injected from the air compressor 500 into the main body part 100; a cylinder 520 having a circular shape, and formed therein with an accommodation space; a piston 530 inserted into the cylinder 520; a piston rod 540 connected to the piston 530, and protruding out of the cylinder 520; and a compressor handle 550 connected to an end of the piston rod 540. In addition, the one-way valve 510 may allow insides of the cylinder 520 and the main body part 100 to communicate with each other, and may be opened only when pressing is performed in the cylinder 520 toward the main body part 100. In addition, the inside of the cylinder 520 may be sealed by the piston 530, and as the piston 530 moves, and the air may be compressed or expanded according to the movement of the piston 530 so as to be introduced into the cylinder 520. In addition, when a user pushes the compressor handle 550 toward an inner side of the cylinder 500, the piston 530 may be moved to the inside of the cylinder 520 so that the air may be compressed, and the air compressed by the piston 530 may be injected into the main body part 100. In other words, the air compressor 500 may be operated by a physical force of the user to fill the air inside the main body part 100 up to an upper limit pressure that is preset in the pressure gauge 112. However, if necessary, a pumping operation may be stopped even at the set upper limit pressure or less.

Hereinafter, a pipe blockage handling device according to a third embodiment of the present invention will be described. The present embodiment is partially different from the first embodiment in that a projectile that is launched by the pressure of the air discharged from the main body part is provided, and the descriptions of the first embodiment will be hereby incorporated by reference for other redundant configurations.

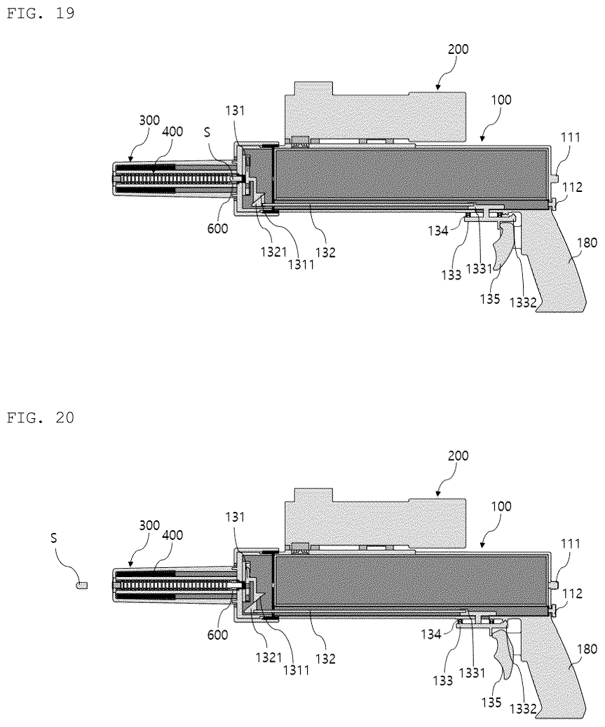

Referring to FIGS. 18 to 20, according to the present invention, the pipe blockage handling device may include: a launch pad 600 that is installable between the main body part 100 and the air pressure discharge part 400; and a projectile S seated on the launch pad 600. For example, the launch pad 600 may be connected to one surface of the communication part 160. In addition, the launch pad 600 may be provided so that the projectile S having a bullet-like shape may be seated. In other words, the launch pad 600 may have a hollow shape so that the projectile S may be seated and temporarily fixed, and the launch pad 600 may be fastened to a portion of an end of the communication part 160 in which the air is discharged. In addition, when the pipe insertion part 300 is connected to the main body part 100 while the projectile S is seated on the launch pad 600, or when the projectile S is pushed and inserted rearward from an end of the pipe insertion part 300 while the pipe insertion part 300 is fastened, the projectile S may be located on an inlet of the air pressure discharge part 400. In addition, when the discharge part trigger 135 is pulled to discharge the air, the projectile S may be launched by the air pressure, and the air pressure discharge part 400 may guide a launch direction of the projectile S. Therefore, the launch pad 600 may serve to load the projectile S, and the projectile S may be launched together with the high-pressure air accumulated in the main body part 100 at a moment when the high-pressure air is discharged through the air pressure discharge part 400 so that the foreign substances that block the pipe may be removed.

In conclusion, according to the present invention, since the pipe insertion part is formed of a flexible rubber material having elasticity and stretchability, air, and the like, even when the inlet of the blocked pipe is small, obstructed, or unbalanced so that the pipe insertion part may not be inserted, the pipe insertion part may expand to an expansion limit so as to be pressed in contact with the outer wall or the inlet of the blocked pipe, so that the pipe insertion part may be deformed to correspond to a shape of the outer wall or the inlet of the pipe so as to be sealed, and thus the high-pressure air in the main body part may be injected into the blocked pipe without leakage, and the foreign substances may be efficiently removed. In addition, according to the present invention, the pipe insertion part may expand in volume while being inserted into the inlet of the blocked pipe, so that the pipe insertion part may make close contact with the inner circumferential surface of the blocked pipe by using an expansion force so as to be sealed, and the high-pressure air in the main body part may be directly inserted between a blocked part of the pipe and the pipe insertion part, and thus a blockage in the pipe may be handled regardless of a diameter and a shape of the pipe. In addition, even when the inlet of the blocked pipe is bent, the air pressure discharge part may be provided in the form of a bellows hose so as to be easily introduced together with the pipe injection part, so that foreign substances in the bent pipe may also be effectively handled. In addition, according to the present invention, the pipe insertion part may expand through the high-pressure air in the main body part, and the air inside the main body part may be recharged to the preset upper limit pressure as needed, so that the recharged high-pressure air may be discharged again through the air pressure discharge part, and thus the foreign substances may be removed more effectively, and a smaller volume may be applied to the main body part. In addition, according to the present invention, a cover device may be provided at the end of the air pressure discharge part 400 to prevent external foreign substances from entering except a case where the air hose H is connected, and a case where the projectile S is launched. In addition, according to the present invention, the accumulator may be provided, so that the high air pressure may be prepared even with a pump and an electric motor having a small capacity and a small output.

The embodiments described above are to be understood as being illustrative but not restrictive in all aspects, the scope of the present invention is defined by the claims described below rather than the above detailed description, and the scope of the present invention is construed to include the meanings and the scope of the claims and all changes or modifications derived from the equivalent concept thereof.

### DESCRIPTION OF REFERENCE NUMERALS

100: Main body part
110: Accumulator
111: Filling part
112: Pressure gauge
120: Injection part valve
121: Injection part cap
1211: First sliding member
1212: First spring
122: Injection part valve rod
1221: Second sliding member
123: Injection part valve operation part
1231: First seating groove part
1232: First hook part
124: First elastic pressing part
130: Discharge part valve
131: Discharge part cap
1311: Third sliding member
1312: Second spring
132: Discharge part valve rod
1321: Fourth sliding member
133: Discharge part valve operation part
1331: Second seating groove part
1332: Second hook part
134: Second elastic pressing part
135: Discharge part trigger
140: Valve partition member
150: Main body partition member
160: Communication part
170: Connection bracket
180: Handle
200: Air compressor
210: One-way valve
220: Pressure restriction switch
300: Pipe insertion part
310: Outer tube
320: Expansion limit pocket
400: Air pressure discharge part
410: Discharge port
500: Air compressor
510: One-way valve
520: Cylinder
530: Piston
540: Piston rod
550: Compressor handle
600: Launch pad
H: Air hose
S: Projectile

1. A pipe blockage handling device comprising:
a main body part in which high-pressure air capable of removing foreign substances that block a pipe is accumulated;
an air compressor connected to one side of the main body part, and configured to accumulate air inside the main body part so that an air pressure inside the main body part is increased to a preset upper limit pressure;
a pipe insertion part connected to an end of the main body part to expand to a preset volume and a preset shape when injected with the air accumulated in the main body part, deformed to correspond to a shape of an outer wall, an inlet, or the like of a blocked pipe so as to seal an inside and an outside of the blocked pipe when pressed in close contact with the outer wall, the inlet, or the like of the blocked pipe, and configured to expand to correspond to a size and a shape of the inside of the pipe to make close contact with an inner circumferential surface of the pipe so as to seal the inside and the outside of the pipe when inserted into the inlet of the blocked pipe; and
an air pressure discharge part provided inside the pipe insertion part, configured to communicate with the main body part, and configured to be bendable,
wherein the air pressure discharge part allows the high-pressure air accumulated inside the main body part to be discharged into the blocked pipe having the inlet that is sealed by the pipe insertion part, so that the foreign substances in the blocked pipe are effectively removed.

2. The pipe blockage handling device of claim 1, wherein the main body part includes:
an injection part valve configured to open and close a portion in which the pipe insertion part and the main body part are connected to each other; and
a discharge part valve configured to open and close a portion in which the air pressure discharge part and the main body part are connected to each other, and
the injection part valve and the discharge part valve allow the air inside the main body part to selectively communicate with the pipe insertion part and the air pressure discharge part so that a flow of the air is controlled.

3. The pipe blockage handling device of claim 1, wherein the main body part includes:
an accumulator provided inside the main body part;
a filling part provided to fill the accumulator with a fluid;
a pressure gauge configured to indicate the pressure inside the main body part; and
a handle provided on one side of the main body part.

4. The pipe blockage handling device of claim 3, wherein the accumulator maintains the air pressure inside the main body part at a high pressure and effectively discharges the air, so that the foreign substances in the blocked pipe are easily removed.

5. The pipe blockage handling device of claim 1, wherein the compressor air includes a pressure restriction switch configured to control an operation of the air compressor to stop when the pressure inside the main body part reaches the preset upper limit pressure.

6. The pipe blockage handling device of claim 1, wherein the pipe insertion part includes:
an outer tube formed of a flexible material having elasticity, and having a hollow shape; and
an expansion limit pocket accommodated between an outer circumferential surface and an inner circumferential surface of the outer tube, formed of a flexible non-elastic material, and configured to communicate with the main body part, and
the air pressure discharge part includes a cover provided on the inner circumferential surface of the expansion limit pocket, provided as a bendable hose having a bellows shape so as to be inserted even into a curved pipe integrally with the pipe insertion part, so that the air is discharged into various types of pipes or holes, and configured to prevent introduction of external foreign substances.

7. The pipe blockage handling device of claim 6, wherein the expansion limit pocket is press-fitted into the outer tube in a form of a folded parachute having a plurality of creases, and expands to a preset volume and a preset shape when injected with the air inside the main body part, so that while the outer tube is prevented from expanding to a limit or more, the pipe insertion part makes close contact with the inlet of the blocked pipe, and the outer tube is prevented from being subjected to plastic deformation.

8. The pipe blockage handling device of claim 1, wherein the air pressure discharge part has an end to which an air hose is connected so as to enable use and air charging of an air tool.

9. The pipe blockage handling device of claim 1, further comprising:
a launch pad that is installable between the main body part and the air pressure discharge part; and
a projectile seated on the launch pad,
wherein the projectile is selectively seated, and launched together with the high-pressure air accumulated in the main body part at a moment when the high-pressure air is discharged through the air pressure discharge part so that the foreign substances that block the pipe is removed.
